(19) United States
(12) Patent Application Publication
(10) Pub. No.: US 2020/0210061 A1
(43) Pub. Date: Jul. 2, 2020

(54) METHOD, DEVICE AND STORAGE MEDIUM FOR SHARING MULTIMEDIA RESOURCE

(71) Applicant: BEIJING XIAOMI MOBILE SOFTWARE CO., LTD., Beijing (CN)

(72) Inventors: Zetan PEI, Beijing (CN); Zhenzhou LU, Beijing (CN); Huiying YANG, Beijing (CN)

(73) Assignee: BEIJING XIAOMI MOBILE SOFTWARE CO., LTD., Beijing (CN)

(21) Appl. No.: 16/586,149

(22) Filed: Sep. 27, 2019

(30) Foreign Application Priority Data
Dec. 28, 2018 (CN) 201811622651.9

(51) Int. Cl. G06F 3/0488; G06F 3/0486; G06F 3/0485

(52) U.S. Cl. CPC G06F 3/04886; G06F 3/0486; G06F 2203/04803; G06F 2203/04804; G06F 2203/04806; G06F 3/0485

(57) ABSTRACT

A method, device and non-transitory storage medium for sharing a multimedia resource are provided. The method includes: displaying, responsive to reception of a preset trigger instruction for any one of multimedia resources on a first page, a first floating window, where the multimedia resource corresponding to the preset trigger instruction is displayed in the first floating window in a thumbnail form; moving, responsive to reception of a first movement instruction for the first floating window, the first floating window to a target area of a screen; after switching to a second page, moving, responsive to reception of a second movement instruction for the first floating window, the first floating window to the second page, where the second page is a page for performing information interaction with a recipient; and sending, responsive to reception of a first release instruction for the first floating window, the multimedia resource to the recipient.

### CROSS-REFERENCE TO RELATED APPLICATION

This application is based upon and claims priority to Chinese Patent Application No. 201811622651.9, filed on Dec. 28, 2018, the disclosure of which is hereby incorporated by reference in its entirety.

### TECHNICAL FIELD

The present disclosure relates to the technical field of electronics, and more particularly, to a method, device and storage medium for sharing a multimedia resource.

### BACKGROUND

In daily work and life, we often encounter such a scenario in which users need to share multimedia resources such as text, shopping links, audio and video links, files or pictures with others through terminals to meet information spread demands.

In a related art, users are generally required to perform multiple operations in order to achieve multimedia resource sharing. For example, for link sharing, a user needs to perform in turn: selecting a link→clicking on a copy option to copy the link to a pasteboard →selecting a recipient→pasting the link→clicking on a sending option; and for picture sharing, the user needs to perform in turn: selecting a picture→downloading the picture→uploading the picture→clicking on the sending option. The above sharing modes result in complicated operation steps and low sharing efficiency, which seriously affect the user experience. In a resource sharing scenario, high efficiency is a necessary performance. For this reason, how to efficiently complete multimedia resource sharing has become an urgent problem to be solved by those skilled in the art.

### SUMMARY

The present disclosure provides a method, device and storage medium for sharing a multimedia resource.

According to a first aspect of the present disclosure, a method for sharing a multimedia resource is provided. The method includes: displaying, responsive to reception of a preset trigger instruction for any one of multimedia resources on a first page, a first floating window, where the multimedia resource corresponding to the preset trigger instruction is displayed in the first floating window in a thumbnail form; moving, responsive to reception of a first movement instruction for the first floating window, the first floating window to a target area of a screen; after switching to a second page, moving, responsive to reception of a second movement instruction for the first floating window, the first floating window to the second page, where the second page is a page for performing information interaction with a recipient; and sending, responsive to reception of a first release instruction for the first floating window, the multimedia resource to the recipient.

According to a second aspect of the present disclosure, a device for sharing a multimedia resource is provided. The device includes: a processor and a memory configured to store instructions executable by the processor. The processor is configured to: display, responsive to reception of a preset trigger instruction for any one of multimedia resources on a first page, a first floating window, where the multimedia resource corresponding to the preset trigger instruction is displayed in the first floating window in a thumbnail form; move, responsive to reception of a first movement instruction for the first floating window, the first floating window to a target area of a screen; move, after switching to a second page, responsive to reception of a second movement instruction for the first floating window, the first floating window to the second page, where the second page is a page for performing information interaction with a recipient; and send, responsive to reception of a first release instruction for the first floating window, the multimedia resource to the recipient.

According to a third aspect of the present disclosure, there is provided a non-transitory storage medium having stored thereon computer program instructions that, when executed by a processor, implement a method for sharing a multimedia resource, where the method includes: displaying, responsive to reception of a preset trigger instruction for any one of multimedia resources on a first page, a first floating window, where the multimedia resource corresponding to the preset trigger instruction is displayed in the first floating window in a thumbnail form; moving, responsive to reception of a first movement instruction for the first floating window, the first floating window to a target area of a screen; after switching to a second page, moving, responsive to reception of a second movement instruction for the first floating window, the first floating window to the second page, where the second page is a page for performing information interaction with a recipient; and sending, responsive to reception of a first release instruction for the first floating window, the multimedia resource to the recipient.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the present disclosure.

FIG. 1 illustrates a flowchart of a method for sharing a multimedia resource according to an example.

FIG. 2 illustrates a flowchart of another method for sharing a multimedia resource according to an example.

FIG. 3 illustrates a schematic diagram of a terminal display interface according to an example.

FIG. 4 illustrates a schematic diagram of another terminal display interface according to an example.

FIG. 5 illustrates a schematic diagram of yet another terminal display interface according to an example.

FIG. 6 illustrates a schematic diagram of still another terminal display interface according to an example.

FIG. 7 illustrates a schematic diagram of still another terminal display interface according to an example.

FIG. 8 illustrates a schematic diagram of still another terminal display interface according to an example.

FIG. 9 illustrates a schematic diagram of still another terminal display interface according to an example.

FIG. 10 illustrates a schematic diagram of still another terminal display interface according to an example.

FIG. 11 illustrates a schematic diagram of still another terminal display interface according to an example.

FIG. 12 illustrates a schematic diagram of still another terminal display interface according to an example.

FIG. 13 illustrates a schematic diagram of still another terminal display interface according to an example.

FIG. 14 illustrates a schematic diagram of still another terminal display interface according to an example.

FIG. 15 illustrates a schematic diagram of still another terminal display interface according to an example.

FIG. 16 illustrates a block diagram of a device for sharing a multimedia resource according to an example.

FIG. 17 illustrates a block diagram of another device for sharing a multimedia resource according to an example.

### DETAILED DESCRIPTION

Reference is made in detail to aspects, examples of which are illustrated in the accompanying drawings. The following description refers to the accompanying drawings in which the same numbers in different drawings represent the same or similar elements unless otherwise represented. The implementations set forth in the following description of examples do not represent all implementations consistent with the present disclosure. Instead, they are merely examples of devices and methods consistent with aspects related to the present disclosure.

The terminology used in the present disclosure is for the purpose of describing particular examples only and is not intended to limit the present disclosure. As used in this disclosure and the appended claims, the singular forms “a”, “an”, and “the” are intended to include the plural forms as well, unless the context clearly indicates otherwise. It should also be understood that the term “and/or” as used herein refers to and includes any and all possible combinations of one or more of the associated listed items.

It should be understood that, although the terms “first,” “second,” “third,” and the like may be used herein to describe various information, the information should not be limited by these terms. These terms are only used to distinguish one category of information from another. For example, without departing from the scope of the present disclosure, first information may be termed as second information; and similarly, second information may also be termed as first information. As used herein, the term “if” may be understood to mean “when” or “upon” or “in response to” depending on the context.

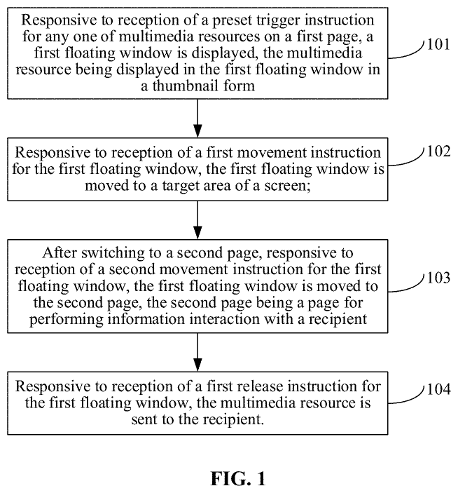

FIG. 1 illustrates a flowchart of a multimedia resource sharing method according to an example. As illustrated in FIG. 1, the method is applied to a terminal, and includes the following operations.

At block 101, responsive to reception of a preset trigger instruction for any one of multimedia resources on a first page, a first floating window is displayed; and the multimedia resource corresponding to the preset trigger instruction is displayed in the first floating window in a thumbnail form.

At block 102, responsive to reception of a first movement instruction for the first floating window, the first floating window is moved to a target area of a screen.

At block 103, after switching to a second page, responsive to reception of a second movement instruction for the first floating window, the first floating window is moved to the second page; and the second page is a page for performing information interaction with a recipient. The recipient may be a sharing object or entity with which the multimedia resource is to be shared.

At block 104, responsive to reception of a first release instruction for the first floating window, the multimedia resource is sent to the recipient.

According to the method provided by the examples of the present disclosure, when a preset trigger operation of a user on any one of multimedia resources on a first page is detected, the multimedia resource may be set in a floating state, that is, a floating window that is convenient for the user to operate may be displayed, and the floating window displays the multimedia resource in a thumbnail form. In addition, the multimedia resource in the floating state can also respond to operations of the user such as movement and release operations, to support movement of the floating window to a target area of a screen and movement of the floating window from the target area to a second page to be sent to a recipient. Since the resource sharing mode is implemented based on a movable floating window, the operation mode is more direct, convenient and simple, and the resource sharing efficiency can be significantly improved, thereby enriching the multimedia resource sharing mode, resulting in a better effect, and avoiding or alleviating the problem of low sharing efficiency.

In an implementation, the operation of moving the first floating window to a target area of a screen includes that:

in a case that the first floating window is a first window to be held, an area of the first page in the screen is reduced after the first floating window is moved to a preset position of the screen, and the first floating window is displayed on the target area newly arranged. The target area is an area other than the reduced area of the first page, and is formed after the area of the first page in the screen is reduced.

In an implementation, the method further includes that:

responsive to reception of preset trigger instructions for M other multimedia resources, M floating windows are displayed in an overlapped form, where M is a positive integer no less than 2;

a first window number identifier is displayed on top of the M overlapped floating windows; and

responsive to reception of a second release instruction for the M floating windows in the target area, the M floating windows are sequentially displayed in the target area.

In an implementation, the method further includes that:

responsive to reception of a first preset instruction for the first floating window within the target area, the first floating window is zoomed in, and background blurring is performed on areas other than the first floating window.

In an implementation, the method further includes that:

responsive to reception of a window viewing instruction within the target area, floating windows held in the target area are displayed in a scrolling manner. Here, the floating windows held in the target area being displayed in a scrolling manner means that windows, which are not displayed on the screen of the terminal due to limitation of the screen of the terminal, can be displayed through the sliding operation. For example, the screen of the terminal displays currently only the first four of the multiple floating windows held in the target area, and if the user wants to see other floating windows held in the target area, the user may perform a sliding operation from right to left, so that other floating windows held in the target area can be displayed in the screen of the terminal.

In an implementation, the method further includes that:

responsive to reception of a third movement instruction for the first floating window within the target area, a display position of the first floating window in the target area is adjusted.

In an implementation, the method further includes that:

responsive to reception of a window overlapping instruction within the target area, N floating windows currently held in the target area are displayed in an overlapped form, where N is a positive integer no less than 2;

a second window number identifier is displayed at a specified position within the target area;

responsive to reception of a fourth movement instruction for the N overlapped floating windows, the N overlapped floating windows are moved from the target area to be above the second page; and

responsive to reception of a third release instruction for the N overlapped floating windows, N multimedia resources currently stored or held within the target area are sent to the recipient.

In an implementation, the method further includes that:

responsive to reception of a fifth movement instruction for X other floating windows, the X floating windows are moved to be above the second page, and the X floating windows are displayed on the second page in an overlapped form, where X is a positive integer no less than 2;

a third window number identifier is displayed on top of the X overlapped floating windows; and

responsive to reception of a fourth release instruction for the X overlapped floating windows, multimedia resources within the X overlapped floating windows are sent to the recipient.

All of the above optional implementations may form optional aspects of the present disclosure in any possible combinations, and will not be further described herein.

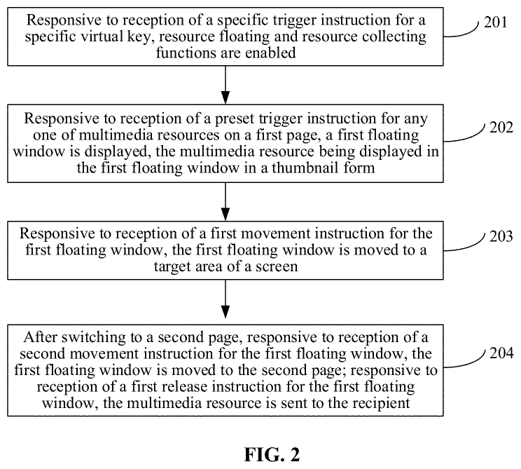

FIG. 2 illustrates a flowchart of a multimedia resource sharing method according to an example. As illustrated in FIG. 2, the method is implemented by a terminal, and includes the following operations.

At block 201, responsive to reception of a specific trigger instruction for a specific virtual key, resource floating and resource collecting functions are enabled.

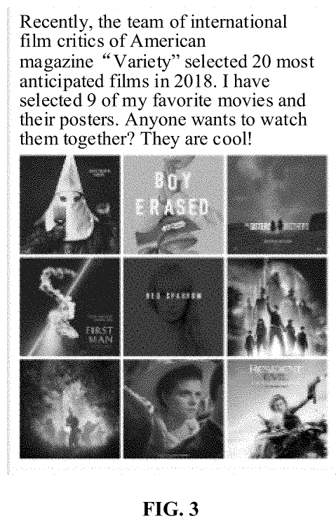

Referring to FIG. 3, during the process of browsing multimedia resources, users often need to share multimedia resources. For example, a passage or paragraph needs to be forwarded. In order to facilitate user operations, the examples of the present disclosure provide a fast and convenient multimedia resource sharing method that provides the multimedia resources in a floating state and supports free movement of the multimedia resources by the users. The multimedia resources include, but are not limited to, text, links, files, pictures, and the like.

In the examples of the present disclosure, the specific virtual key is a switch that enables a global content floating function and supports the user to freely move the multimedia resource in the floating state. For example, a display position of the specific virtual key may be a system setting interface, which is not specifically limited in the examples of the present disclosure. When the terminal receives a specific trigger instruction of a user for the specific virtual key, that is, after the user turns on the switch, the terminal enters a content collection state. The specific trigger instruction may be a click operation on the specific virtual key, which is not specifically limited in the examples of the present disclosure.

At block 202, responsive to reception of a preset trigger instruction for any one of multimedia resources on a first page, a first floating window is displayed. The multimedia resource is displayed in the first floating window in a thumbnail form.

It is to be noted that the first, second, third, fourth, etc. herein do not constitute a special limitation on multimedia resources or floating windows, and these terms are only used to distinguish different multimedia resources or floating windows. The preset trigger instruction includes, but is not limited to, a long press instruction, a copy instruction, a download instruction and the like. The pressing duration corresponds to the long press instruction may be 1 second or 2 seconds, etc., which is not specifically limited in the examples of the present disclosure. In the examples of the present disclosure, when the user presses any multimedia resource, the multimedia resource may float and may be attached to the finger of the user. In another way, the long press operation triggers the display of the floating window.

For a text type multimedia resource, the thumbnail form may be a title of the passage or some words at the beginning of the passage; for a picture type multimedia resource, the thumbnail form may be a thumbnail of the picture.

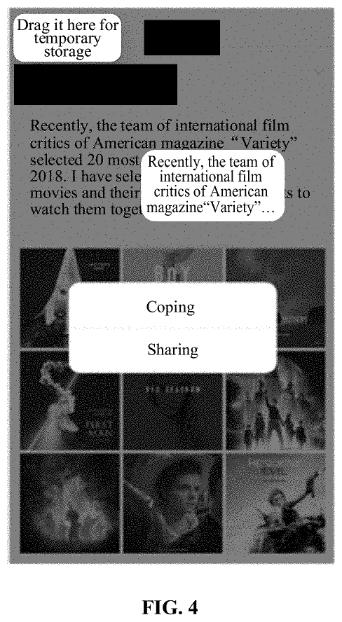

For example, referring to FIG. 4, if the terminal detects that the user has long pressed a text portion illustrated in the figure, the terminal will float the text, that is, the text is placed in a floating window, and the floating window is attached to the finger of the user, thereby facilitating user operation. Meanwhile, the first page will also synchronously display a resource collection container in a bring-to-front manner to facilitate the user to store or hold multimedia resources. The resource collection container may be displayed at any position of a display screen. For example, in order to prevent the resource collection container from excessively covering a lower part of the display page, the resource collection container may be displayed at a corner of the display screen, such as an upper left corner as shown in FIG. 4.

Here, the bring-to-front manner means that the resource collection container is displayed at the forefront when it is displayed in the foreground, that is, displayed at the front end of all the pages, or on the top of all the pages.

The resource collection container may display a prompt message prompting the user to temporarily store the multimedia resources, where the prompt message may be words such as “drag it here for temporary storage”, and the examples of the present disclosure do not specifically limit.

At block 203, responsive to reception of a first movement instruction for the first floating window, the first floating window is moved to a target area of a screen.

For this operation, if the user presses and holds the first floating window and moves toward the location of the resource collection container, the terminal will place the first floating window in a selected state, and acquire a movement trajectory of the finger of the user in real time, so as to display the first floating window on the first page in real time.

In an implementation, the operation of moving the first floating window to the target area of the screen includes that: in a case that the first floating window is a first window to be held, an area of the first page in the screen is reduced after the first floating window is moved to a preset position of the screen, and the first floating window is displayed on the newly arranged target area.

The preset position of the screen is the location of the resource collection container. The examples of the present disclosure realize a display effect similar to the split screen. When the first floating window is moved to the location of the resource collection container, the terminal reduces the area of the first page displayed on a lower layer with respect to the first floating window in the screen or the display screen. For example, a currently displayed application interface is reduced to leave some space on the display screen, and the space is used to store the floating window moved or dragged by a user.

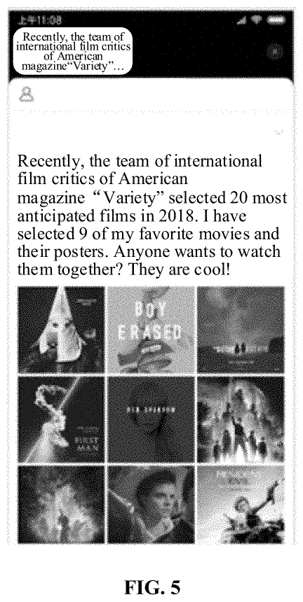

For example, referring to FIG. 5, in a case that the newly generated first floating window is a first window to be held, the terminal reduces the area of the first page in the display screen after the first floating window is moved to the preset position of the screen, and the first floating window is displayed on a newly arranged free area, where the free area is referred to herein as a target area.

It is to be noted that the target area is usually located at a boundary position of the display screen, such as the top of the screen, the bottom of the screen, the left side of the screen, or the right side of the screen, which is not limited by the examples of the present disclosure. In FIG. 5, the target area appears at the top of the screen and is available for the user to store multiple floating windows.

At block 204, after switching to a second page, responsive to reception of a second movement instruction for the first floating window, the first floating window is moved to be above the second page; and responsive to reception of a first release instruction for the first floating window, the multimedia resource is sent to a recipient.

The second page is a page for performing information interaction with the recipient, that is, an application interface for sending a multimedia resource. In addition, if the second page is a chat interface of a social type application, the recipient is a friend of the local user.

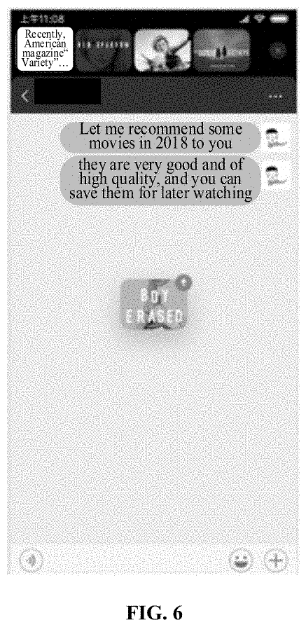

In the examples of the present disclosure, the multimedia resource in a floating state is a floating window, which supports the user to drag or move at will. If the user wants to send the first floating window displayed within the target area to others, after the terminal is switched from the first page to the second page, as illustrated in FIG. 6, the user may press or hold the first floating window within the target area, and move the first floating window from the target area to be above the second page. After the user loosens the finger on the second page, the terminal receives a first release instruction for the first floating window, and sends the multimedia resource to the recipient.

In addition, referring to FIG. 6, a sending prompt icon may also be displayed in the upper right corner of the first floating window to remind the user. A display position of the sending prompt icon may also be the upper left corner, the lower left corner, or the lower right corner, which is not specifically limited in the examples of the present disclosure.

According to the method provided by the examples of the present disclosure, when a preset trigger operation of a user on any one of multimedia resources on a first page is detected, the multimedia resource may be set in a floating state, that is, a floating window that is convenient for the user to operate may be displayed, and the floating window displays the multimedia resource in a thumbnail form. In addition, the multimedia resource in the floating state can also respond to operations of the user such as movement and release operations, to support movement of the floating window to a target area of a screen and movement of the floating window from the target area to a second page to be sent to a recipient. Since the resource sharing mode is implemented based on a movable floating window, the operation mode is more direct, convenient and simple, and the resource sharing efficiency can be significantly improved, thereby enriching the multimedia resource sharing mode and resulting in a better effect.

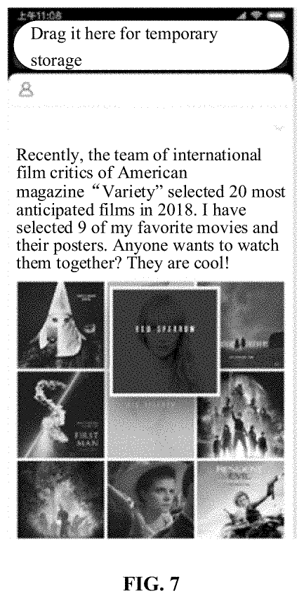

In an implementation, the resource collection container can store multiple multimedia resources. That is, the target area of the screen can store multiple floating windows. If the first floating window is the first stored window, the storing process for the non-first stored floating window is as follows: responsive to reception of a preset trigger instruction for a multimedia resource A, the target area is displayed in the form of the resource collection container. The floating window A displays the multimedia resource A in a thumbnail form. For example, compared with FIG. 5, when the finger of the user long presses the multimedia resource A, in addition to displaying the floating window A, the target area illustrated in FIG. 5 is also converted into the form of the resource collection container illustrated in FIG. 7 to guide the user to continue to store the multimedia resources.

In an implementation, the examples of the present disclosure also support moving multiple floating windows to the target area of the screen at one time. For example, when the terminal receives preset trigger instructions for M other multimedia resources, M floating windows are displayed in an overlapped form, M being a positive integer no less than 2. A first window number identifier is displayed on top of the M overlapped floating windows. For example, the topmost one of the M overlapped floating windows may be a newly selected floating window, and the first window number identifier indicates a total number M of floating windows currently subjected to overlapping displaying.

In an implementation, when the M overlapped floating windows are moved to the location of the resource collection container, the resource collection container is switched to be displayed in the form of the target area. When a second release instruction for the M floating windows is received in the target area, the M floating windows are sequentially displayed on the target area. For example, when the terminal receives the second release instruction for the overlapped M floating windows in the target area, the M overlapped floating windows are displayed in the target area in a chronological order. The chronological order may be an order of selection time from early to late, which is not specifically limited in the examples of the present disclosure.

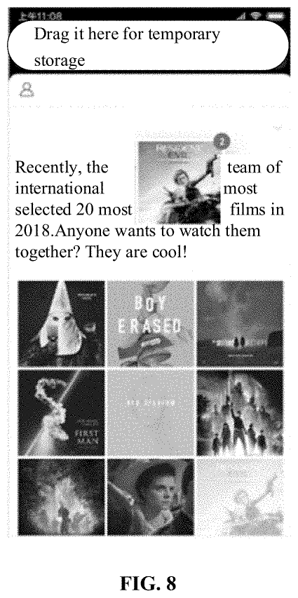

For example, referring to FIG. 8, in a case that the user presses a floating window with one finger and has not moved the floating window to the resource collection container, if the user continues to use another finger to long press another multimedia resource, the another multimedia resource may be floated likewise and attached together with the former to achieve the gathering of the floating windows. As illustrated in FIG. 8, since two floating windows are currently attached, two floating windows are displayed in an overlapped form, and a total number of floating windows currently attached to the finger is displayed on the upper right corner of the topmost one of the overlapped the floating windows. The two floating windows are moved to the top of the screen so as to store or hold the two floating windows in the target area.

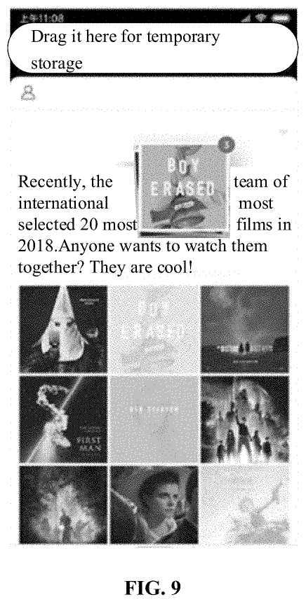

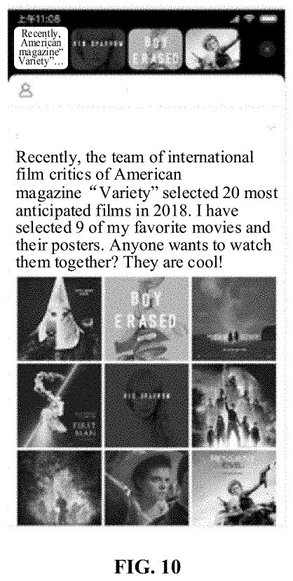

Referring to FIG. 9, the examples of the present disclosure further support the user to gather more floating windows under the finger. For example, three floating windows are gathered in FIG. 9, and accordingly, the total number of floating windows displayed also changes. Similarly, referring to FIG. 10, since three floating windows are gathered, after moving the overlapped floating windows to the target area, the three floating windows are sequentially displayed in the target area.

In addition, as can be seen from FIG. 10, the earliest stored floating window is arranged at the leftmost side of the target area, and the three floating windows stored together are sorted according to the selected order. That is, the order in which the floating windows are arranged in the target area is related to the position of the target area on the display screen and the time of storage (i.e. the time point at which the floating window is stored). If the storage times of any two floating windows are the same, the two floating windows are sorted according to the selected time (i.e. the time point at which the floating window is selected), which is not specifically limited in the examples of the present disclosure.

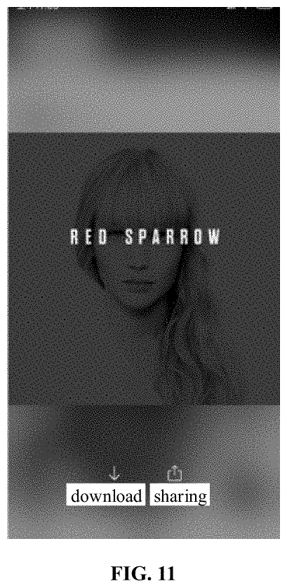

In an implementation, the examples of the present disclosure also support zooming in and viewing of any one of the floating windows displayed in the target area. For example, responsive to reception of a first preset instruction for the first floating window located within the target area, the first floating window is zoomed in, and background blurring is performed on areas other than the first floating window. The blurring process may be a Gaussian blurring process, which is not specifically limited in the examples of the present disclosure. Comparing FIG. 10 and FIG. 11, when the user clicks on the second floating window displayed in the top area of the screen (i.e. the target area) from left to right, the terminal zooms in that floating window, so that the user can view the details of the picture displayed by the floating window, and simultaneously, Gaussian blurring is performed on all backgrounds except the picture.

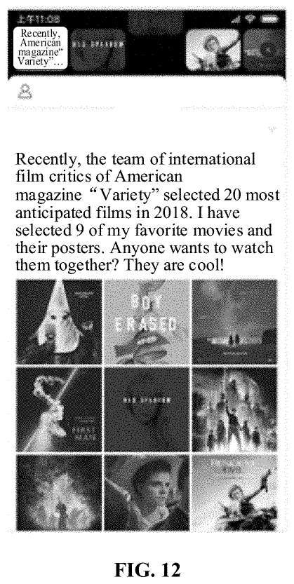

In an implementation, the examples of the present disclosure support deleting of any one of the floating windows displayed in the target area. That is, responsive to reception of a deletion instruction for any one of the floating windows displayed in the target area, the corresponding floating window is deleted. The deletion instruction is generated based on a detected first sliding gesture. As illustrated in FIG. 12, the first sliding gesture may be a sliding gesture from bottom to top, which is not specifically limited in the examples of the present disclosure. Comparing FIG. 10 and FIG. 12, when the user presses the third floating window displayed in the target area from left to right and performs the sliding gesture from bottom to top, the terminal deletes that floating window.

In an implementation, multiple floating windows may be held within the target area. However, not all floating windows in the target area are displayed on the screen due to the size limitation of the display screen. For this reason, the examples of the present disclosure also support scrolling display of floating windows held in the target area. That is, responsive to reception of a window viewing instruction within the target area, the terminal displays in a scrolling manner, floating windows held in the target area. The window viewing instruction is generated based on a detected second sliding gesture. The second sliding gesture is adapted to the position of the target area. For example, if the target area is located at the top of the screen, the second sliding gesture may be a left-to-right sliding screen gesture or a right-to-left sliding screen gesture, which is not specifically limited in the examples of the present disclosure.

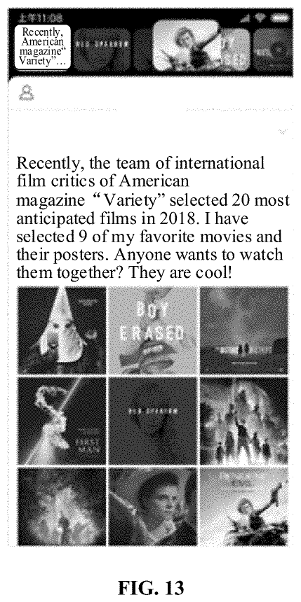

In an implementation, the examples of the present disclosure also support sorting adjustment of the positions of respective floating windows displayed in the target area. For example, responsive to reception of a third movement instruction for the first floating window within the target area, a display position of the first floating window in the target area is adjusted. For example, when a movement instruction for the first floating window within the target area is received, the terminal acquires a distance between the first floating window and other floating windows currently displayed in the order, and adjusts a display position of the first floating window within the target area based on the distance. In another way, referring to FIG. 13, the user can adjust the display position of the floating window by pressing any one of the floating windows to move within the target area. For example, when the user presses and holds a floating window to be moved within the target area, if both a distance between the floating window after moving and one other floating window and a distance between the floating window after moving and another floating window are less than a fixed threshold, the floating window is inserted and displayed between those two floating windows.

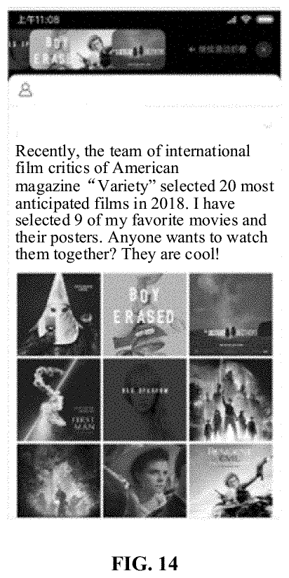

In an implementation, the examples of the present disclosure also support overlapping of multiple floating windows within the target area. That is, responsive to reception of a window overlapping instruction within the target area, N floating windows currently held in the target area are displayed in an overlapped form, N being a positive integer no less than 2; and a second window number identifier is displayed at a specified position within the target area. The window overlapping instruction is generated based on a detected third sliding gesture or a two-finger pinching gesture. The third sliding gesture is adapted to the position of the target area. If the target area is located at the top of the screen, the third sliding gesture may be a fast right-to-left sliding screen gesture, and the specified position may be the upper right corner of the target area, which is not specifically limited in the examples of the present disclosure. For example, referring to FIG. 14, a right-to-left sliding operation or a two-finger pinching operation is performed in the target area located at the top of the screen, and multiple floating windows held in the target area may be overlapped. For example, the multiple floating windows in the target area may be partially overlapped, such that the user is able to view the content of the floating windows while more floating windows may be held and viewable in the target area.

In an implementation, the N floating windows in an overlapped state may be moved together to the second page of the target application and may all be sent. That is, responsive to reception of a fourth movement instruction for N overlapped floating windows, the N overlapped floating windows are moved from the target area to be above the second page; and responsive to reception of a third release instruction for the N overlapped floating windows, N multimedia resources currently stored within the target area are sent to the recipient.

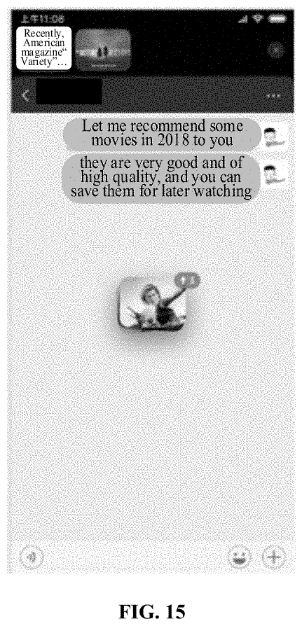

In an implementation, referring to FIG. 15, after the user moves a floating window to be above the second page, if the user does not release the finger, but uses other fingers to continue to select other floating windows, multiple floating windows can be gathered under the finger, that is, the examples of the present disclosure support multi-selection sending. In another way, responsive to reception of a fifth movement instruction for X other floating windows in the target area, the X floating windows are moved to be above the second page, and the X floating windows are displayed on the second page in an overlapped form, X being a positive integer no less than 2. A third window number identifier and a sending prompt identifier are displayed on top of the X overlapped floating windows; and responsive to reception of a fourth release instruction for the X overlapped floating windows, multimedia resources within the X floating windows are sent to the recipient.

According to the examples of the present disclosure, a multimedia resource can be stored in a small space at the edge of a screen through a system-level resource capture capability, and a user can move and store the multimedia resource in a floating state at will. Such gestures of moving and sending are very in line with the user's intuition and the content is completely visible, so the whole process is controlled by the user, the resource sharing efficiency is high, and the user experience is good.

In detail, for a scenario in which a resource needs to be shared quickly or multiple resources need to be shared, not only the floating-and-moving based resource sharing mode provided by the examples of the present disclosure can greatly improve the sharing efficiency, but also the user directly manipulates the resource itself to simulate the real life scenario. The interaction mode is very easy to learn and easy to remember. In addition, such an interaction mode can assist in popularizing gesture interactions, which will help the product to develop in a direction that is closer to the user's intuition and more in line with a natural interaction scenario.

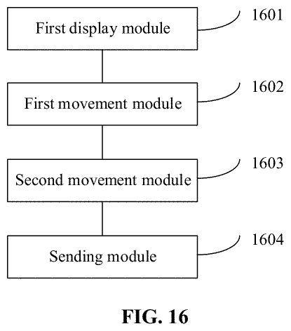

FIG. 16 illustrates a block diagram of a device for sharing a multimedia resource according to an example. Referring to FIG. 16, the device includes a first display module 1601, a first movement module 1602, a second movement module 1603, and a sending module 1604.

The first display module 1601 is configured to display, responsive to reception of a preset trigger instruction for any one of multimedia resources on a first page, a first floating window. The multimedia resource corresponding to the preset trigger instruction is displayed in the first floating window in a thumbnail form.

The first movement module 1602 is configured to move, responsive to reception of a first movement instruction for the first floating window, the first floating window to a target area of a screen.

The second movement module 1603 is configured to receive, after switching to a second page, a second movement instruction for the first floating window, and move the first floating window to the second page, the second page being a page for performing information interaction with a recipient.

The sending module 1604 is configured to send, responsive to reception of a first release instruction for the first floating window, the multimedia resource to the recipient.

According to the device provided by the examples of the present disclosure, when a preset trigger operation of a user on any one of multimedia resources on a first page is detected, the multimedia resource may be set in a floating state, that is, a floating window that is convenient for the user to operate may be displayed, and the floating window displays the multimedia resource in a thumbnail form. In addition, the multimedia resource in the floating state can also respond to operations of the user such as movement and release operations, to support movement of the floating window to a target area of a screen and movement of the floating window from the target area to a second page to be sent to a recipient. Since the resource sharing mode is implemented based on a movable floating window, the operation mode is more direct, convenient and simple, and the resource sharing efficiency can be significantly improved, thereby enriching the multimedia resource sharing mode and resulting in a better effect.

In an implementation, the first movement module is further configured to reduce, in a case that the first floating window is a first window to be held, an area of the first page in the screen after the first floating window is moved to a preset position of the screen, and display the first floating window on the newly arranged target area.

In an implementation, the device further includes a second display module.

The second display module is configured to: display, responsive to reception of preset trigger instructions for M other multimedia resources, M floating windows in an overlapped form, M being a positive integer no less than 2; display a first window number identifier on top of the M overlapped floating windows; and sequentially display, responsive to reception of a second release instruction for the M floating windows in the target area, the M floating windows in the target area.

In an implementation, the device further includes a third display module.

The third display module is configured to zoom in, responsive to reception of a first preset instruction for the first floating window within the target area, the first floating window, and perform background blurring on areas other than the first floating window.

In an implementation, the device further includes a fourth display module.

The fourth display module is configured to display in a scrolling manner, responsive to reception of a window viewing instruction in the target area, floating windows held in the target area.

In an implementation, the device further includes a fifth display module.

The fifth display module is configured to adjust, responsive to reception of a third movement instruction for the first floating window within the target area, a display position of the first floating window in the target area.

In an implementation, the device further includes a sixth display module.

The sixth display module is configured to: perform, responsive to reception of a window overlapping instruction within the target area, N floating windows currently held in the target area are displayed in an overlapped form, N being a positive integer no less than 2; and display a second window number identifier at a specified position within the target area.

The second movement module is further configured to move, responsive to reception of a fourth movement instruction for the N overlapped floating windows, the N overlapped floating windows from the target area to the second page.

The sending module is further configured to send, responsive to reception of a third release instruction for the N overlapped floating windows, N multimedia resources currently stored within the target area to the recipient.

In an implementation, the device further includes a seventh display module.

The second movement module is further configured to move, responsive to reception of a fifth movement instruction for X other floating windows in the target area, the X floating windows to the second page, X being a positive integer no less than 2.

The seventh display module is configured to display the X floating windows on the second page in an overlapped form, and display a third window number identifier on top of the X overlapped floating windows.

The sending module is further configured to send, responsive to reception of a fourth release instruction for the X overlapped floating windows, multimedia resources within the X floating windows to the recipient.

All of the above optional implementations may form optional aspects of the present disclosure in any possible combinations, and will not be further described herein.

With regard to the device in the above examples, the specific manner in which the respective modules perform the operations has been described in detail in the example relating to the method, and will not be explained in detail herein.

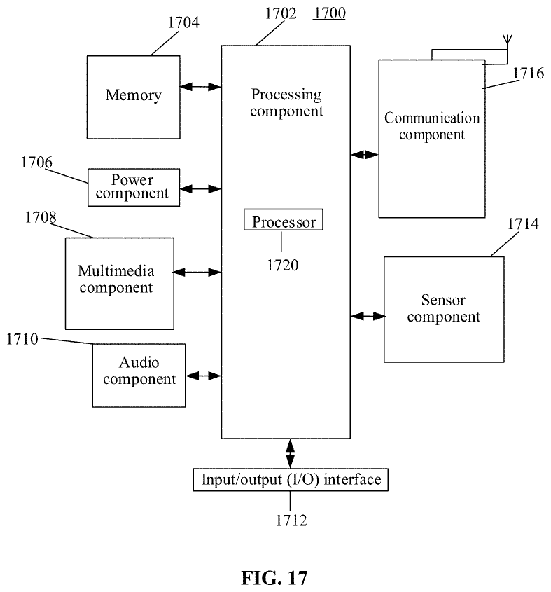

FIG. 17 illustrates a block diagram of a multimedia resource sharing device 1700 according to an example. For example, the device 1700 may be a mobile phone, a computer, a digital broadcast terminal, a messaging device, a gaming console, a tablet, a medical device, exercise equipment, a personal digital assistant, and the like.

In some aspects, there is provided a device for sharing a multimedia resource, including a processor; and a memory configured to store instructions executable by the processor, where the processor is configured to: display, responsive to reception of a preset trigger instruction for any one of multimedia resources on a first page, a first floating window, where the multimedia resource corresponding to the preset trigger instruction is displayed in the first floating window in a thumbnail form; move, responsive to reception of a first movement instruction for the first floating window, the first floating window to a target area of a screen; move, after switching to a second page, responsive to reception of a second movement instruction for the first floating window, the first floating window to the second page, wherein the second page is a page for performing information interaction with a recipient; and send, responsive to reception of a first release instruction for the first floating window, the multimedia resource to the recipient.

Referring to FIG. 17, the device 1700 may include one or more of the following components: a processing component 1702, a memory 1704, a power component 1706, a multimedia component 1708, an audio component 1710, an input/output (I/O) interface 1712, a sensor component 1714, and a communication component 1716.

The processing component 1702 typically controls overall operations of the device 1700, such as the operations associated with display, telephone calls, data communications, camera operations, and recording operations. The processing component 1702 may include one or more processors 1720 to execute instructions to perform all or part of the steps in the above described methods. Moreover, the processing component 1702 may include one or more modules which facilitate the interaction between the processing component 1702 and other components. For example, the processing component 1702 may include a multimedia module to facilitate the interaction between the multimedia component 1708 and the processing component 1702.

The memory 1704 is configured to store various types of data to support the operation of the device 1700. Examples of such data include instructions for any applications or methods operated on the device 1700, contact data, phonebook data, messages, pictures, video, etc. The memory 1704 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1706 provides power to various components of the device 1700. The power component 1706 may include a power management system, one or more power sources, and any other components associated with the generation, management, and distribution of power in the device 1700.

The multimedia component 1708 includes a screen providing an output interface between the device 1700 and the user. In some examples, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some examples, the multimedia component 1708 includes a front camera and/or a rear camera. The front camera and the rear camera may receive an external multimedia datum while the device 1700 is in an operation mode, such as a photographing mode or a video mode. Each of the front camera and the rear camera may be a fixed optical lens system or have focus and optical zoom capability.

The audio component 1710 is configured to output and/or input audio signals. For example, the audio component 1710 includes a microphone (“MIC”) configured to receive an external audio signal when the device 1700 is in an operation mode, such as a call mode, a recording mode, and a voice recognition mode. The received audio signal may be further stored in the memory 1704 or transmitted via the communication component 1716. In some examples, the audio component 1710 further includes a speaker to output audio signals.

The I/O interface 1712 provides an interface between the processing component 1702 and peripheral interface modules, such as a keyboard, a click wheel, buttons, and the like. The buttons may include, but are not limited to, a home button, a volume button, a starting button, and a locking button.

The sensor component 1714 includes one or more sensors to provide status assessments of various aspects of the device 1700. For example, the sensor component 1714 may detect an open/closed status of the device 1700, relative positioning of components, e.g., the display and the keypad, of the device 1700, a change in position of the device 1700 or a component of the device 1700, a presence or absence of user contact with the device 1700, an orientation or an acceleration/deceleration of the device 1700, and a change in temperature of the device 1700. The sensor component 1714 may include a proximity sensor configured to detect the presence of nearby objects without any physical contact. The sensor component 1714 may also include a light sensor, such as a complementary metal oxide semiconductor (CMOS) or charge-coupled device (CCD) image sensor, for use in imaging applications. In some examples, the sensor component 1714 may also include an accelerometer sensor, a gyroscope sensor, a magnetic sensor, a pressure sensor, or a temperature sensor.

The communication component 1716 is configured to facilitate communication, wired or wirelessly, between the device 1700 and other devices. The device 1700 can access a wireless network based on a communication standard, such as WiFi, 2G, or 3G, or a combination thereof. In one example, the communication component 1716 receives a broadcast signal or broadcast associated information from an external broadcast management system via a broadcast channel. In one example, the communication component 1716 further includes a near field communication (NFC) module to facilitate short-range communications.

In some examples, the device 1700 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above multimedia resource sharing method.

In some examples, there is also provided a non-transitory computer readable storage medium including instructions, such as included in the memory 1704, executable by the processor 1720 in the device 1700, for performing the above method. For example, the non-transitory computer-readable storage medium may be a ROM, a random access memory (RAM), a compact disc read-only memory (CD-ROM), a magnetic tape, a floppy disc, an optical data storage device, and the like.

A non-transitory computer-readable storage medium is provided. When an instruction in the storage medium is executed by a processor 1720 of the device 1700, the device 1700 is enabled to perform the above multimedia resource sharing method.

The present disclosure may include dedicated hardware implementations such as application specific integrated circuits, programmable logic arrays and other hardware devices. The hardware implementations can be constructed to implement one or more of the methods described herein. Applications that may include the apparatus and systems of various examples can broadly include a variety of electronic and computing systems. One or more examples described herein may implement functions using two or more specific interconnected hardware modules or devices with related control and data signals that can be communicated between and through the modules, or as portions of an application-specific integrated circuit. Accordingly, the computing system disclosed may encompass software, firmware, and hardware implementations. The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. The module refers herein may include one or more circuit with or without stored code or instructions. The module or circuit may include one or more components that are connected.

Other examples of the disclosure will be apparent to those skilled in the art from consideration of the specification and practice of the present disclosure. This application is intended to cover any variations, uses, or adaptations of the present disclosure following the general principles thereof and including such departures from the present disclosure as come within known or customary practice in the art. It is intended that the specification and examples be considered as exemplary only.

It will be appreciated that the present disclosure is not limited to the exact construction that has been described above and illustrated in the accompanying drawings, and that various modifications and changes can be made without departing from the scope thereof.

What is claimed is:

1. A method for sharing a multimedia resource, comprising:
displaying, responsive to reception of a preset trigger instruction for any one of multimedia resources on a first page, a first floating window, wherein the multimedia resource corresponding to the preset trigger instruction is displayed in the first floating window in a thumbnail form;
moving, responsive to reception of a first movement instruction for the first floating window, the first floating window to a target area of a screen;
after switching to a second page, moving, responsive to reception of a second movement instruction for the first floating window, the first floating window to the second page, wherein the second page is a page for performing information interaction with a recipient; and
sending, responsive to reception of a first release instruction for the first floating window, the multimedia resource to the recipient.

2. The method of claim 1, wherein moving the first floating window to the target area of the screen comprises:
where the first floating window is a first window to be held, reducing an area of the first page in the screen after the first floating window is moved to a preset position of the screen, and displaying the first floating window in the target area which is newly formed.

3. The method of claim 2, further comprising:
displaying, responsive to reception of preset trigger instructions for M other multimedia resources, M floating windows in an overlapped form, wherein M is a positive integer no less than 2;
displaying a first window number identifier on top of the M overlapped floating windows; and
sequentially displaying, responsive to reception of a second release instruction for the M floating windows in the target area, the M floating windows in the target area.

4. The method of claim 1, further comprising:
zooming in, responsive to reception of a first preset instruction for the first floating window in the target area, the first floating window, and performing background blurring on areas other than the first floating window.

5. The method of claim 1, further comprising:
displaying in a scrolling manner, responsive to reception of a window viewing instruction in the target area, floating windows held within the target area.

6. The method of claim 1, further comprising:
adjusting, responsive to reception of a third movement instruction for the first floating window in the target area, a display position of the first floating window in the target area.

7. The method of claim 1, further comprising:
displaying in an overlapped form, responsive to reception of a window overlapping instruction in the target area, N floating windows held in the target area, wherein N is a positive integer no less than 2;
displaying a second window number identifier at a specified position in the target area;
moving, responsive to reception of a fourth movement instruction for the N overlapped floating windows, the N overlapped floating windows from the target area to the second page; and
sending, responsive to reception of a third release instruction for the N overlapped floating windows, N multimedia resources stored within the target area to the recipient.

8. The method of claim 1, further comprising:
moving, responsive to reception of a fifth movement instruction for X other floating windows held in the target area, the X floating windows to the second page, and displaying the X floating windows on the second page in an overlapped form, wherein X is a positive integer no less than 2;
displaying a third window number identifier on top of the X overlapped floating windows; and
sending, responsive to reception of a fourth release instruction for the X overlapped floating windows, multimedia resources within the X overlapped floating windows to the recipient.

9. A device for sharing a multimedia resource, comprising:
a processor; and
a memory configured to store instructions executable by the processor,
wherein the processor is configured to:
display, responsive to reception of a preset trigger instruction for any one of multimedia resources on a first page, a first floating window, wherein the multimedia resource corresponding to the preset trigger instruction is displayed in the first floating window in a thumbnail form;
move, responsive to reception of a first movement instruction for the first floating window, the first floating window to a target area of a screen;
move, after switching to a second page, responsive to reception of a second movement instruction for the first floating window, the first floating window to the second page, wherein the second page is a page for performing information interaction with a recipient; and
send, responsive to reception of a first release instruction for the first floating window, the multimedia resource to the recipient.

10. The device of claim 9, wherein the processor is further configured to:
where the first floating window is a first window to be held, reduce an area of the first page in the screen after the first floating window is moved to a preset position of the screen, and display the first floating window in the target area which is newly formed.

11. The device of claim 10, wherein the processor is further configured to:
display, responsive to reception of preset trigger instructions for M other multimedia resources, M floating windows in an overlapped form, wherein M is a positive integer no less than 2;
display a first window number identifier on top of the M overlapped floating windows; and
sequentially display, responsive to reception of a second release instruction for the M floating windows in the target area, the M floating windows in the target area.

12. The device of claim 9, wherein the processor is further configured to: zoom in, responsive to reception of a first preset instruction for the first floating window in the target area, the first floating window, and perform background blurring on areas other than the first floating window.

13. The device of claim 9, wherein the processor is further configured to:
display in a scrolling manner, responsive to reception of a window viewing instruction in the target area, floating windows held within the target area.

14. The device of claim 9, wherein the processor is further configured to:
adjust, responsive to reception of a third movement instruction for the first floating window in the target area, a display position of the first floating window in the target area.

15. The device of claim 9, wherein the processor is further configured to:
display in an overlapped form, responsive to reception of a window overlapping instruction in the target area, N floating windows held in the target area, wherein N is a positive integer no less than 2;
display a second window number identifier at a specified position in the target area;
move, responsive to reception of a fourth movement instruction for the N overlapped floating windows, the N overlapped floating windows from the target area to the second page; and
send, responsive to reception of a third release instruction for the N overlapped floating windows, N multimedia resources stored within the target area to the recipient.

16. The device of claim 9, wherein the processor is further configured to:
move, responsive to reception of a fifth movement instruction for X other floating windows held in the target area, the X floating windows to the second page, and display the X floating windows on the second page in an overlapped form, wherein X is a positive integer no less than 2;
display a third window number identifier on top of the X overlapped floating windows; and
send, responsive to reception of a fourth release instruction for the X overlapped floating windows, multimedia resources within the X overlapped floating windows to the recipient.

17. A non-transitory storage medium having stored thereon computer program instructions that, when executed by a processor, implement a method for sharing a multimedia resource, wherein the method comprises:
displaying, responsive to reception of a preset trigger instruction for any one of multimedia resources on a first page, a first floating window, wherein the multimedia resource corresponding to the preset trigger instruction is displayed in the first floating window in a thumbnail form;
moving, responsive to reception of a first movement instruction for the first floating window, the first floating window to a target area of a screen;
after switching to a second page, moving, responsive to reception of a second movement instruction for the first floating window, the first floating window to the second page, wherein the second page is a page for performing information interaction with a recipient; and
sending, responsive to reception of a first release instruction for the first floating window, the multimedia resource to the recipient.

18. The non-transitory storage medium of claim 17, wherein moving the first floating window to the target area of the screen comprises:
in a case that the first floating window is a first window to be held, reducing an area of the first page in the screen after the first floating window is moved to a preset position of the screen, and displaying the first floating window in the target area which is newly formed.

19. The non-transitory storage medium of claim 17, wherein the method further comprises:
displaying, responsive to reception of preset trigger instructions for M other multimedia resources, M floating windows in an overlapped form, wherein M is a positive integer no less than 2;
displaying a first window number identifier on top of the M overlapped floating windows; and
sequentially displaying, responsive to reception of a second release instruction for the M floating windows in the target area, the M floating windows in the target area.

20. The non-transitory storage medium of claim 17, wherein the method further comprises:
displaying in an overlapped form, responsive to reception of a window overlapping instruction in the target area, N floating windows held in the target area, wherein N is a positive integer no less than 2;
displaying a second window number identifier at a specified position in the target area;
moving, responsive to reception of a fourth movement instruction for the N overlapped floating windows, the N overlapped floating windows from the target area to the second page; and
sending, responsive to reception of a third release instruction for the N overlapped floating windows, N multimedia resources stored within the target area to the recipient.
